(19) United States
(12) Patent Application Publication
(10) Pub. No.: US 2014/0313917 A1
(43) Pub. Date: Oct. 23, 2014

(54) METHOD FOR TRANSMITTING DATA AND ELECTRONIC DEVICE THEREOF

(71) Applicant: Samsung Electronics Co., Ltd., Gyeonggi-do (KR)

(72) Inventors: Chan-Ho Jung, Seoul (KR); Woo-Sung Lee, Gyeonggi-do (KR)

(73) Assignee: Samsung Electronics Co., Ltd., Gyeonggi-do (KR)

(21) Appl. No.: 14/259,062

(22) Filed: Apr. 22, 2014

(30) Foreign Application Priority Data
Apr. 22, 2013 (KR) 10-2013-0044084

(51) Int. Cl. H04L 12/26

(52) U.S. Cl. CPC H04L 43/062
USPC 370/252

(57) ABSTRACT

A method for deciding a User Datagram Protocol (UDP) connection method or a Transmission Control Protocol (TCP) connection method and transmitting/receiving data includes the operations of transmitting data to a second electronic device in a UDP method, receiving feedback information about reception of the data, from the second electronic device, and transmitting partial data of the data, the partial corresponding to the feedback information in a TCP method or the UDP method. The feedback information includes information about the partial data failing in reception among the data.

### PRIORITY

The present application is related to and claims priority under 35 U.S.C. §119(a) to a Korean Patent Application No. 10-2013-0044084 filed in the Korean Intellectual Property Office on Apr. 22, 2013, the contents of which are herein incorporated by reference.

### TECHNICAL FIELD

The present disclosure relates to a method for transmitting data and an electronic device thereof.

### BACKGROUND

With the growth of mobile communication technologies, an electronic device is used as an essential communication device of the individual. Further, the electronic device is evolving into a multimedia device providing various services such as camera, data communication, broadcast, video playing, audio playing, messenger, schedule management, alarming functions and the like in addition to a voice communication function.

The electronic device can transmit/receive data with a second electronic device using a Transmission Control Protocol (TCP) method, a User Datagram Protocol (UDP) method and the like. The UDP connection method can have a high rate because transmitting data to all electronic devices at a time, but can increase a possibility in which a portion of transmitted data is lost, particularly, a possibility in which data is lost in a wireless network environment. The TCP connection method has no worry about a loss of data during data transmission/reception, but can have a relatively low rate because connecting all electronic devices with each other and transmitting/receiving data.

Also, although the wireless network environment uses many Access Points (APs), a great change can be made in a data transmission rate according to a time point intending to transmit/receive data but, because a transmission method is implemented to employ only one of the TCP connection method and the UDP connection method, there is a need to select a suitable transmission method according to the environment.

Accordingly, as the electronic device is miniaturized and provides various services that use wireless communication, various methods for implementing reliable UDP transmission capable of making much use of the UDP connection method of a data transmission/reception rate higher than that of the TCP connection method and decreasing a data loss are being devised.

### SUMMARY

To address the above-discussed deficiencies, it is a primary object to provide a fast and reliable data transmission/reception environment by transmitting, by an electronic device, data to a second electronic device in a UDP connection method, after the data transmission, receiving a retransmission request feedback for lost partial data of the transmitted data from the second electronic device, and retransmitting the lost partial data to the second electronic device in the UDP connection method or a TCP connection method.

Another aspect of the present disclosure is to provide a fast and reliable data transmission/reception environment by receiving, by an electronic device, data from a second electronic device in a UDP connection method, after the data reception, sending a network communication environment and a retransmission request feedback for lost partial data of the received data to the second electronic device, and re-receiving the lost partial data from the second electronic device in the UDP connection method or a TCP connection method.

The above aspects are achieved by providing a method for transmitting data and an electronic device thereof.

According to one aspect of the present disclosure, a method for transmitting data in an electronic device is provided. The method may include the operations of transmitting data to a second electronic device in a User Datagram Protocol (UDP) method, receiving feedback information about reception of the data, from the second electronic device, and transmitting partial data of the data, the partial corresponding to the feedback information in a Transmission Control Protocol (TCP) method or the UDP method. The feedback information may include information about the partial data failing in reception among the data.

According to another aspect of the present disclosure, a method for receiving data in an electronic device is provided. The method may include the operations of receiving transmitted data from a second electronic device in a UDP method, transmitting feedback information about the data received from the second electronic device, to the second electronic device, and receiving partial data of the data, the partial corresponding to the feedback information in a TCP method or the UDP method. The feedback information may include information about the partial data failing in reception among the data.

According to a further aspect of the present disclosure, an electronic device may include at least one processor for executing computer programs, at least one communication system for communicating with a second electronic device, at least one memory for storing data and instructions, and at least one program stored in the memory and executed by the at least one processor. The program may include an instruction of processing to transmit data to a second electronic device in a UDP method, processing to receive feedback information about reception of the data, from the second electronic device, and processing to transmit partial data of the data, the partial data corresponding to the feedback information in a TCP method or the UDP method.

According to a yet another aspect of the present disclosure, an electronic device may include at least one processor for executing computer programs, at least one communication system for communicating with a second electronic device, at least one memory for storing data and instructions, and at least one program stored in the memory and executed by the at least one processor. The program may include an instruction of processing to receive transmitted data from a second electronic device in a UDP method, processing to transmit feedback information about the data received from the second electronic device, to the second electronic device, and processing to receive partial data of the data, the partial data corresponding to the feedback information in a TCP method or the UDP method.

According to a still another aspect of the present disclosure, a program may include an instruction of processing to include as feedback information at least one among information about partial data failing in reception among data and information about a data reception rate of receiving the data from a second electronic device in a UDP method, a damage percentage of data reception of the UDP method, and a data transmission/reception rate of a TCP method.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a construction of an electronic device according to the first embodiment of the present disclosure;

FIG. 2 is a diagram illustrating an operation of an electronic device according to the second embodiment of the present disclosure;

FIG. 3 is a diagram illustrating an operation of an electronic device according to the third embodiment of the present disclosure;

FIG. 4 is a diagram illustrating an operation of an electronic device according to the fourth embodiment of the present disclosure;

FIG. 5 is a flowchart illustrating a program operation in an electronic device according to the fifth embodiment of the present disclosure;

FIG. 6A is a flowchart illustrating a program operation in an electronic device according to the sixth embodiment of the present disclosure;

FIG. 6B is a flowchart illustrating a program operation in an electronic device according to the seventh embodiment of the present disclosure;

FIG. 7 is a diagram illustrating data transmitted/received in an electronic device according to the eighth embodiment of the present disclosure;

FIG. 8 is a diagram illustrating a construction of a User Interface (UI) operation dependent on data processing in an electronic device according to the ninth embodiment of the present disclosure; and

FIG. 9 is a diagram illustrating a construction of a UI operation dependent on data processing in an electronic device according to the tenth embodiment of the present disclosure.

### DETAILED DESCRIPTION

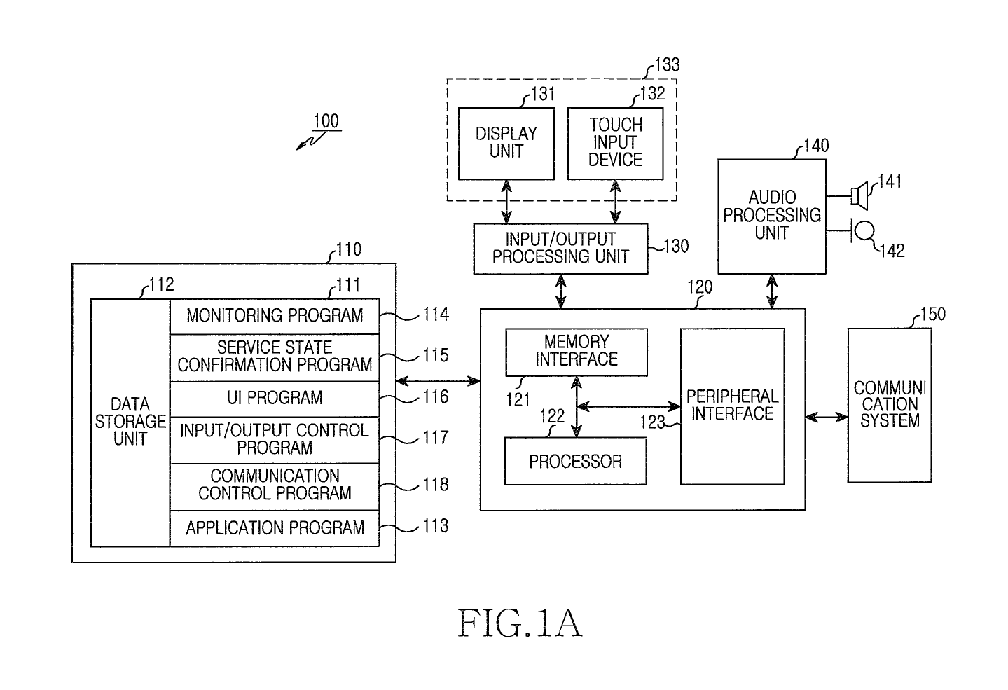

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Preferred embodiments of the present disclosure will be described herein below with reference to the accompanying drawings. In the following description, well-known functions or constructions are not described in detail since they would obscure the disclosure in unnecessary detail. And, terms described below, which are defined considering functions in the present disclosure, can be different depending on user and operator's intention or practice. Therefore, the terms should be defined on the basis of the disclosure throughout this specification.

In the following description of an embodiment of the present disclosure, an electronic device can include a mobile communication terminal, a Personal Digital Assistant (PDA), a Personal Computer (PC), a laptop computer, a smart phone, a smart TV, a netbook, a Mobile Internet Device (MID), an Ultra Mobile PC (UMPC), a tablet PC, a mobile pad, a media player, a handheld computer, a navigator, an MPEG-1 Audio Layer-3 (MPEG3), and a server.

In the following description of an embodiment of the present disclosure, an electronic device can be described by means of a device including a touch screen capable of performing on a single screen a process of inputting through an input device and a process of displaying through a display unit. Accordingly, although the display unit and the input device are separately illustrated in a device construction of the present disclosure, the display unit can include the input device or the input device can be represented by the display unit.

The present disclosure is not limited only to an electronic device including a touch screen, and would be able to be applied to various electronic devices which include a display unit and an input device physically separated and distinguished or include only one of the display unit and the input device. In the following embodiment, an electronic device with a touch screen can represent an electronic device including a display unit, by means of the touch screen including a touch input device and a display unit, the display unit not including the touch input device, the display unit including the touch input device, and the like.

In a detailed description of the present disclosure below, when it is mentioned that one constituent element is ‘connected’ or ‘accessed’ to another constituent element, it should be understood that one constituent element can be directly connected or accessed to another constituent element or the third constituent element can exist in between the two constituent elements. In contrast, when it is mentioned that one constituent element is ‘directly connected’ or ‘directly accessed’ to another constituent element, it should be understood that the third constituent element does not exist in between the two constituent elements.

FIG. 1 illustrates a construction of an electronic device according to the first embodiment of the present disclosure.

As illustrated in FIG. 1, the electronic device 100 can include a memory 110 and a processor unit 120, and its peripheral devices can include an input/output processing unit 130, a display unit 131, a touch input device 132, an audio processing unit 140, a communication system 150, and other peripheral devices.

The components of electronic device are described as follows.

The memory 110 can include a program storage unit 111 storing a program for controlling an operation of the electronic device 100 or a data storage unit 112 storing data generated during program execution. The memory 110 can store data generated in a program through an operation of a processor 122, and the like.

For example, the data storage unit 112 can store data received from a second electronic device (not shown), and can store feedback data for the received data, and can store information data about a network communication environment or state between the electronic device 100 and the second electronic device, and the like.

Also, the data storage unit 112 can store data transmitted by the electronic device 100 to the second electronic device, data splitting the data into data blocks of a predetermined volume, information data about the split data, and the like.

Also, when the electronic device 100 splits data to be transmitted to the second electronic device into data blocks of a predetermined volume through a monitoring program 114 and the like, the data storage unit 112 can store a data table or database that can provide a basis of splitting the data considering a network communication state with the second electronic device, or the like.

The program storage unit 111 can include at least one application program 113, the monitoring program 114, a service state check program 115, a User Interface (UI) program 116, an input/output control program 117, and a communication control program 118. Here, the program included in the program storage unit 111 can be configured as a set of instructions and be expressed as an instruction set.

The monitoring program 114 can process the electronic device 100 to decide a UDP connection method or a TCP connection method according to a network communication environment with the second electronic device or a data transmission/reception state and transmit/receive data with the second electronic device through the communication system 150. The monitoring program 114 can decide the volume of data blocks of the transmitted data with reference to information of the database to split the data into the data blocks. Or, the monitoring program 114 can decide a delay time between the transmitted data blocks to transmit the data.

For another example, if the monitoring program 114 receives a feedback for damage data of received data from the second electronic device, the monitoring program 114 can retransmit the damage data to the second electronic device in the UDP connection method or the TCP connection method with reference to a network communication environment with the second electronic device, a data transmission/reception state, information about the damage data included in the received feedback, or the like.

For further example, if the electronic device 100 receives data from the second electronic device, the electronic device 100 can send the second electronic device a feedback that includes a data reception rate and information about damaged or lost data and the like of the received data.

The service state check program 115 can include at least one software constituent element for checking a state of service provided by the program or constituent elements of the electronic device 100.

The UI program 116 includes at least one instruction, software constituent element for providing a user interface to the electronic device 100.

For example, the UI program 116 can perform conversion into a character or sound corresponding to a code of encoding of a standard character used in the electronic device 100, a character set, and the like, and output the conversion result to a touch screen 133 of the electronic device 100, a speaker 141, or the like.

The input/output control program 117 can display an operation of the electronic device 100 on the display unit 131, and receive an input of an operation instruction of the electronic device 100 through the touch input device 132.

The communication control program 118 can include at least one software constituent element for controlling communication with at least one second electronic device using the communication system 150.

For instance, the communication control program 118 can search a second electronic device for connecting communication. If the second electronic device for communication connection is searched, the communication control program 118 can set a connection for communication with the second electronic device. After that, the communication control program 118 can control to perform a procedure of performance search and session establishment with the connected second electronic device and transmit/receive data such as alarm information and the like with the second electronic device through the communication system 150.

The application program 113 can include a software constituent element for at least one application program installed in the memory 110 of the electronic device 100.

The memory 110 included in the electronic device 100 can be constructed in plural. Also, according to use, the memory 110 can perform a function of only the program storage unit 111, or perform a function of only the data storage unit 112, or perform a function of all of both. Physical region division within the memory 110 can be unclear because of device characteristics.

The processor unit 120 includes a memory interface 121, at least one processor 122 and peripheral interface 123. Here, the memory interface 121, the at least one processor 122 and peripheral interface 123 can be integrated as at least one circuit or be implemented as separate constituent elements.

The memory interface 121 can control the access of a constituent element such as the processor 122 or the peripheral interface 123 to the memory 110.

The peripheral interface 123 can control the connection of the processor 122 and the memory interface 121 with an input/output peripheral device of the electronic device 100.

The processor 122 can control the electronic device 100 to provide various multimedia and communication services and the like using at least one software program. The processor 122 can display to confirm a UI operation of the electronic device 100 on the display unit 131 through the input/output processing unit 130. The processor 122 can control to provide a service of receiving, by an input device (not shown) or the touch input device 132, an input of an instruction from the external of the electronic device 100. At this time, the processor 122 can control to execute at least one program stored in the memory 110 and provide a service corresponding to the executed program.

The audio processing unit 140 can provide an audio interface between a user and the electronic device 100 through the speaker 141 and the microphone 142.

The communication system 150 performs a communication function. For example, the communication system 150 can perform communication with the second electronic device using at least any one of mobile communication using a base station, local area wireless communication such as Infrared Data Association (IrDA), Bluetooth, Wireless Fidelity (WiFi) and the like, Wireless Local Area Network (WLAN) communication, and wired communication.

The input/output processing unit 130 can provide an interface between an input/output device such as the display unit 131, the touch input device 132, and the like, and the peripheral interface 123.

The touch input device 132 can provide input data generated by user's selection to the processor unit 120 through the input/output processing unit 130.

For example, the touch input device 132 can be composed of only a control button in order to receive data for control from the external of the electronic device 100, or can be composed of a key pad.

For another example, the touch input device 132 can be included in the display unit 131 like the touch screen 133. At this time, the touch input device 132 of the touch screen 133 can use a capacitive method, a resistive (pressure sensing) method, an infrared method, an electromagnetic induction method, an ultrasonic method, and the like.

The display unit 131 can receive status information of the electronic device 100, characters input from the external, a moving picture, a still picture or the like from the processor unit 120 and construct and display a UI operation of the electronic device 100 through the input/output control unit 131.

The touch screen 133 is a device physically combining the touch input device 132 with the display unit 131. In an operation of the electronic device 100, the touch screen 133 can input an instruction by touching a screen displayed on the display unit 131.

Accordingly, the touch screen 133 can play roles of both the display unit 131 displaying the UI operation of the electronic device 100 and the touch input device 132 inputting an external instruction to the electronic device 100. Therefore, in the following description, the display unit 131 of the touch screen 133 and the touch input device 132 of the touch screen 133 can be expressed as the touch screen 133.

In describing an embodiment of the present disclosure, displaying or outputting to the electronic device 100 can use a method of displaying a moving picture, a still picture, a Graphical User Interface (GUI) operation or the like on the touch screen 133 of the electronic device 100 or a second display unit or a method of outputting an audio such as a signal sound, a voice or the like to the speaker 141. The following description also can use the displaying or outputting in similar meaning, and can separately describe the displaying or outputting when there is a need to distinguish them.

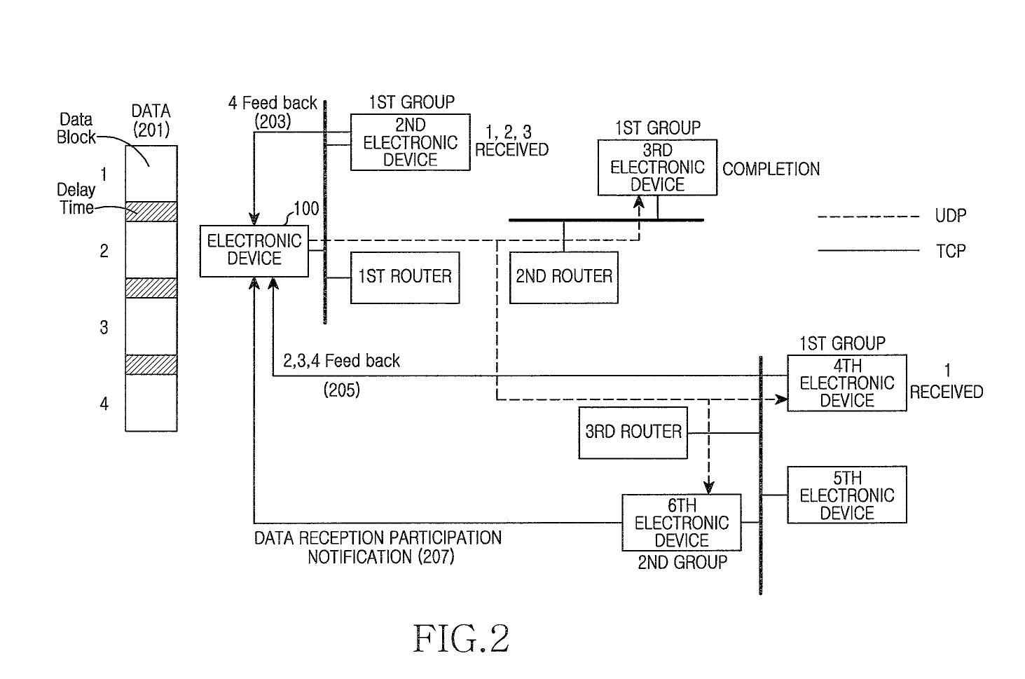

FIG. 2 illustrates an operation of an electronic device according to the second embodiment of the present disclosure.

Referring to FIG. 2, the electronic device 100 can transmit/receive data through a UDP multicast connection method, and can receive a feedback for damage data through a TCP connection method.

The electronic device 100 can transmit/receive data with an electronic device performing network communication such as a third electronic device, a fourth electronic device, or the like of a different network, via a router.

The router can be a device such as an Access Point (AP) through which data can pass when the electronic device 100 and the second electronic device transmit/receive the data with each other. The router is a device for, when different networks are connected with each other to exchange information, identifying a receiving target included in data transmission information (e.g., a packet) and transmitting the information to a different communication network using the most suitable communication channel. For example, the router can relay a network communication between different Local Area Networks (LANs) or connect the local area network to a Wide Area Network (WAN). The router is a device necessarily required for accessing the internet, and can play a role of establishing a channel to transmit information between communication networks operated using different protocols.

The electronic device 100 can transmit data to electronic devices belonging to the same multicast group, in a UDP connection method. A multicast transmission method is a transmission method capable of transmitting, if once forwarding sequential data to a group address, the data to all electronic devices belonging to the same multicast group. As illustrated in FIG. 2, if the electronic device 100 transmits data 201 targeting electronic devices belonging to a first group, the data 201 can be received by the electronic devices belonging to the first group such as a second electronic device, a third electronic device, and a fourth electronic device, via at least one router.

When transmitting/receiving data in a UDP connection method, the electronic device 100 can transmit/receive the data in various methods such as a unicast method, a broadcast methods and the like as well as the multicast method.

The electronic device 100 can split the data 201 into data blocks ‘1’, ‘2’, ‘3’, and ‘4’ of a reference volume, and can include data identification codes in the split data blocks ‘1’, ‘2’, ‘3’, and ‘4’, and can transmit the data blocks ‘1’, ‘2’, ‘3’, and ‘4’ through a communication system.

If a second electronic device or other electronic devices belonging to the same multicast group fails to receive data transmitted by the electronic device 100 or the data is damaged, it can be a data damage resulting from a network communication environment, or it can be a data deformation resulting from external effects such as interference and the like, it or can be a data loss resulting from the expiration of a Time To Live (TTL) of the data caused by the UDP connection method.

The second electronic device can receive the data blocks ‘1’, ‘2’, and ‘3’ among the data blocks ‘1’, ‘2’, ‘3’, and ‘4’ of the data 201 from the electronic device 100, and can transmit reception failure feedback data (203) including information about the data block ‘4’ (i.e., damage data or loss data) failing in reception to the electronic device 100. When the second electronic device transmits the reception failure feedback data (203) to the electronic device 100, the second electronic device can transmit in the TCP connection method.

Here, the UDP connection method can provide a relatively high data transmission/reception rate compared to the TCP connection method, but can cause a damage or loss of data in a data transmission/reception process. Accordingly, reception failure feedback data for damaged data can be transmitted in the TCP connection method causing no data damage, for the sake of efficient data transmission/reception between the electronic device 100 and the second electronic device. Also, even when the electronic device 100 retransmits data corresponding to the received reception failure feedback data to the second electronic device, the electronic device 100 can retransmit in the TCP connection method.

The electronic device 100 can retransmit data corresponding to damage data information included in the received reception failure feedback data, to the second electronic device. At this time, the electronic device 100 can retransmit the data in the TCP connection method or the UDP connection method.

Further, the second electronic device can send a request for transmission of the data block ‘4’ failing in reception to the third electronic device which has succeeded in receiving the data block ‘4’.

For example, if the third electronic device receives all the data blocks ‘1’, ‘2’, ‘3’, and ‘4’ of the data 201 from the electronic device 100, the third electronic device can transmit reception completion feedback data including information notifying that it has completely received the data blocks ‘1’, ‘2’, ‘3’, and ‘4’, to the electronic device 100 or a first group network. The second electronic device can transmit reception completion feedback data including information notifying that it has completely received the data blocks ‘1’, ‘2’, and ‘3’ or reception failure feedback data including information notifying that it has failed to receive the data block ‘4’, to the electronic device 100 or the first group network. The fourth electronic device can transmit reception completion feedback data including information notifying that it has completely received the data block ‘1’ or reception failure feedback data including information notifying that it has failed to receive the data blocks ‘2’, ‘3’, and ‘4’, to the electronic device 100 or the first group network.

The electronic device 100 can transmit to the first group network, etc. data including information about data 201 reception states of the electronic devices belonging to the first group, with reference to feedback information such as reception completion feedback data or reception failure feedback data that can be received from the electronic devices belonging to the first group or be confirmed in the first group network, etc. The second electronic device can confirm the third electronic device having received only the data block ‘4’ from the electronic device 100, with reference to information of the data including the information about the data 201 reception states of the electronic devices belonging to the first group, and can request for the third electronic device to transmit the data block ‘4’ that the second electronic device fails to receive, to the second electronic device.

A sixth electronic device belonging to a second group can transmit to the electronic device 100 participation notification data 207 notifying that it will participate in receiving the data 201. If the electronic device 100 receives the participation notification data 207 from the sixth electronic device, the electronic device 100 can transmit participation confirmation data, which includes information of data intended to be transmitted, data information (i.e., information about data blocks) transmitted up to now, and the like, to the sixth electronic device having transmitted the participation notification data 207.

The sixth electronic device can receive the participation confirmation data from the electronic device 100. Then, the sixth electronic device can participate in the first group and receive the data 201 from the electronic device 100 in the first group network. If there is a data block failing in reception (i.e., data damage) among the data 201 transmitted by the electronic device 100, the sixth electronic device can transmit reception failure feedback data in the TCP connection method. If the electronic device 100 receives the reception failure feedback data from the sixth electronic device, the electronic device 100 can retransmit data corresponding to the reception failure feedback data in the TCP connection method, the UDP connection method or the like.

The electronic device 100 can receive the reception failure feedback data from the electronic devices belonging to the first group, and can retransmit data corresponding to the reception failure feedback data to the electronic devices belonging to the first group in the TCP connection method or the UDP connection method. If at least two or more electronic devices fail to receive common data corresponding to damage data in the retransmission process, the electronic device 100 can retransmit the common data in the UDP connection method, or can retransmit each in the TCP connection method.

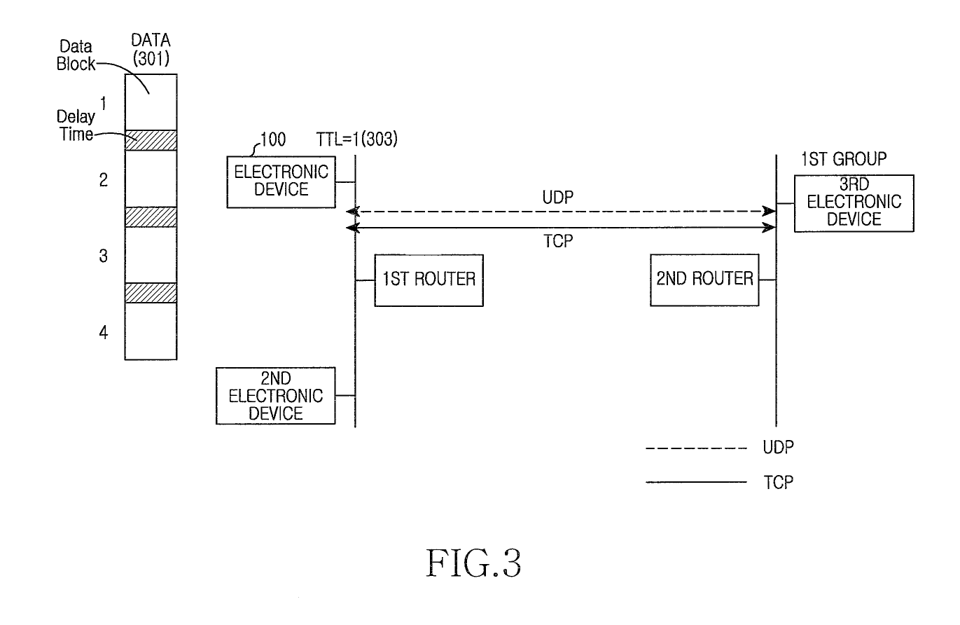

FIG. 3 is a diagram illustrating an operation of an electronic device according to the third embodiment of the present disclosure.

The electronic device 100 can reset a data transmission method according to a network situation of a second electronic device or a third electronic device receiving data 301 that is transmitted by the electronic device 100 in a UDP multicast transmission method and the like, and transmit the data 301 in the reset data transmission method.

For example, when the electronic device 100 transmits the data 301 through a UDP connection method, the electronic device 100 can decide a TTL to transmit the data 301. The data 301 transmitted by the electronic device 100 can expire if going through a router as many as a decided TTL count. Accordingly, when receiving the data 301 from the electronic device 100, the second electronic device or third electronic device can fail to receive some or all of the data 301 from the electronic device 100.

Referring to FIG. 3, the electronic device 100 can decide a TTL as ‘1’ to transmit the data 301, and a first router can exist between the electronic device 100 and the second electronic device. The data 301 transmitted by the electronic device 100 may not go through a second router because the TTL becomes ‘0’ if the data 301 passes through the first router, but the second electronic device having a connection with the first router can receive the data 301 transmitted by the electronic device 100. When transmitting the data 301, the UDP connection method can damage or lose some or all of the data 301 according to a network communication environment. For example, according to a request of the second electronic device, the electronic device 100 can transmit data blocks ‘1’, ‘2’, ‘3’, and ‘4’ splitting the data 301 to a first group network to which the second electronic device belongs, and the second electronic device can receive the data blocks ‘1’, ‘1’, ‘2’, and ‘4’ in the first group network. The second electronic device can process the repeatedly received data block ‘1’ through data identification information and the like of the electronic device 100, and can send the electronic device 100 a request for retransmission of the data block ‘3’ failing in reception. The electronic device 100 can retransmit the data block ‘3’ to the second electronic device in the TCP connection method.

For another example, the electronic device 100 can decide the TTL as ‘1’ to transmit the data 301, and two routers (i.e., a first router and a second router) can exist between the electronic device 100 and the third electronic device. The data 301 transmitted by the electronic device 100 can expire without passing through the second router, because the TTL becomes ‘0’ if the data 301 passes through the first router. The third electronic device can transmit participation notification data and the like to the electronic device 100 to request for transmission of the data 301 to the electronic device 100. If reception of the requested data 301 is not initiated within a response waiting time, the third electronic device can determine it as data damage, data loss or the like, and can send a request for retransmission of the data 301 to the electronic device 100. If the electronic device 100 confirms the retransmission request of the third electronic device, the electronic device 100 can retransmit the corresponding data 301 in the TCP connection method and the like.

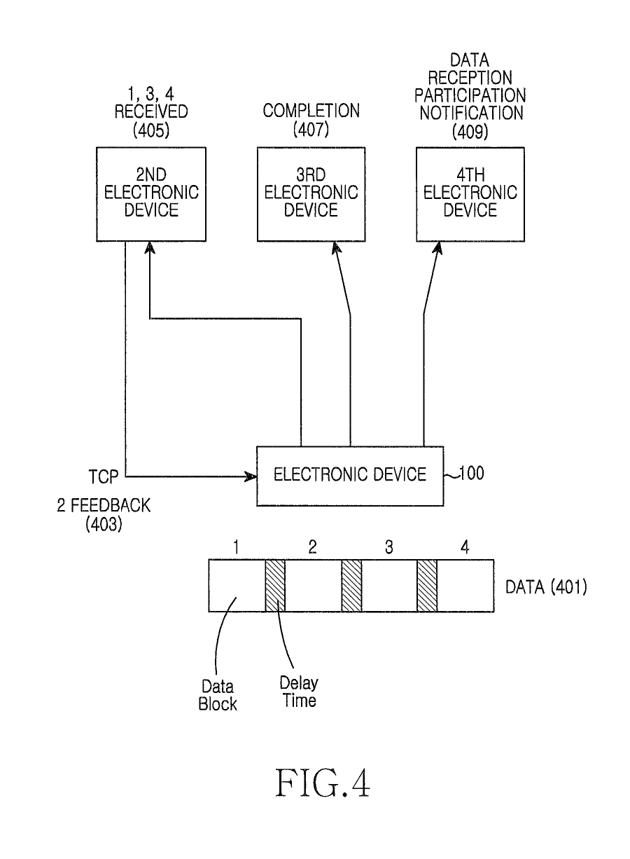

FIG. 4 is a diagram illustrating an operation of an electronic device according to the fourth embodiment of the present disclosure.

The electronic device 100 can reset a data transmission method according to a network situation of a second electronic device, a third electronic device, or a fourth electronic device receiving data 401 that is transmitted by the electronic device 100 in a UDP broadcast transmission method and the like, and transmit the data 401 in the reset data transmission method.

For example, when transmitting the data 401 in the UDP broadcast transmission method, the electronic device 100 can decide electronic devices that will transmit the data 401 to an Internet Protocol (IP), a port and the like, and the electronic device 100 can transmit the same data 401 to the decided respective electronic devices.

Referring to FIG. 4, the electronic device 100 can simultaneously transmit the same data 401 to the respective electronic devices belonging to the same network or the same broadcast group, and the electronic device 100 can transmit the data 401 targeting the fourth electronic device according to a data 401 transmission request of the fourth electronic device.

The electronic device 100 can transmit the data 401 split into data blocks ‘1’, ‘2’, ‘3’, and ‘4’ to the second electronic device. Some or all of the data 401 can be damaged or lost according to a network communication environment. The second electronic device can receive the data blocks ‘1’, ‘3’, and ‘4’ of the data 401 among which the data block ‘2’ is damaged or lost. The second electronic device can send (403) the electronic device 100 a data reception failure feedback notifying that it has failed to receive the data block ‘2’ and a data reception success feedback notifying that it has succeeded in receiving the data blocks ‘1’, ‘3’, and ‘4’, in the TCP connection method and the like, and can send the electronic device 100 a request for retransmission of the data block ‘2’. According to the retransmission request of the second electronic device, the electronic device 100 can retransmit the data block ‘2’ to the second electronic device in the TCP connection method, the UDP connection method, or the like.

For another example, the electronic device 100 can transmit the data 401 split into the data blocks ‘1’, ‘2’, ‘3’ and ‘4’ to the third electronic device. The third electronic device can receive all of the data 401 transmitted by the electronic device 100 without damage, and can send a data reception success feedback notifying that it has succeeded in receiving the data 401, in the TCP connection method and the like.

For further example, the electronic device 100 can transmit the data 401 split into data blocks ‘1’, ‘2’, ‘3’ and ‘4’ according to the data 401 transmission request of the fourth electronic device. Some or all of the data blocks ‘1’, ‘2’, ‘3’ and ‘4’ of the data 401 can be damaged or lost according to a network communication environment. The fourth electronic device can send the electronic device 100 a data reception failure feedback including information about data blocks failing in reception, in the TCP connection method and the like to request for retransmission of the data blocks failing in reception to the electronic device 100. The electronic device 100 can retransmit the corresponding data blocks, to the fourth electronic device in the TCP connection method, the UDP connection method or the like.

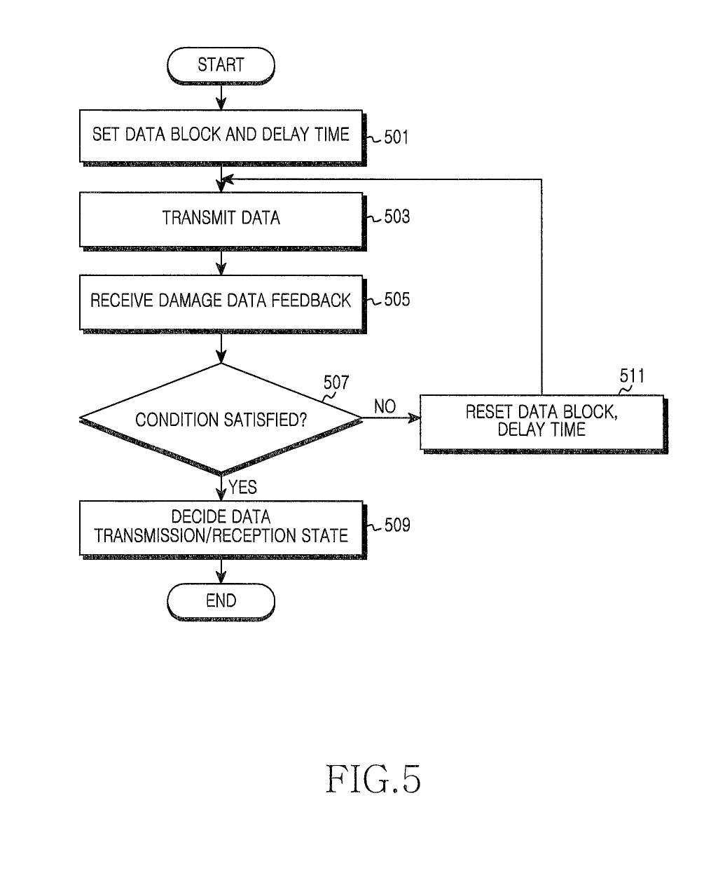

FIG. 5 illustrates a program operation in an electronic device according to the fifth embodiment of the present disclosure.

When transmitting data to a second electronic device, the electronic device 100 can decide a communication connection method such as a TCP connection method, a UDP connection method or the like according to a network communication environment.

Prior to a description of FIG. 5, the features of the TCP connection method and the UDP connection method will be described below.

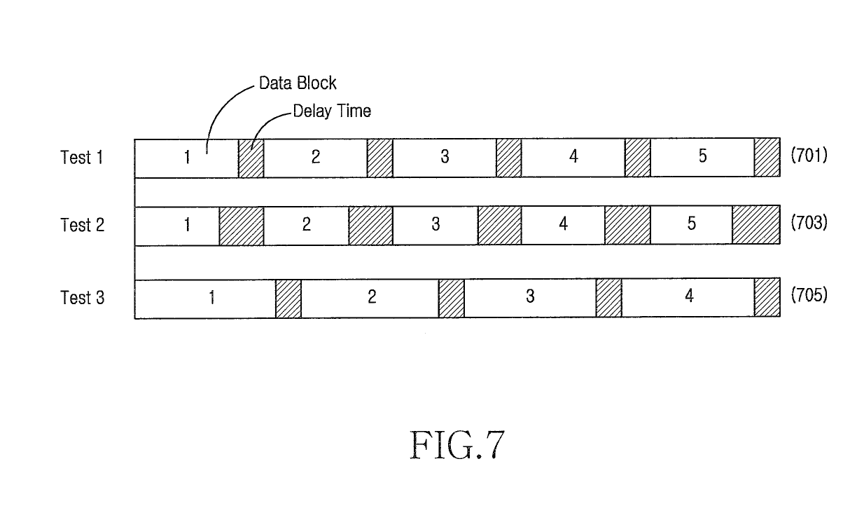

The TCP connection method has a need to connect communication between the electronic device 100 and the second electronic device when the electronic device 100 transmits data (e.g., 705 of FIG. 7) split into data blocks ‘1’, ‘2’, ‘3’ and ‘4’ to the second electronic device. The electronic device 100 can send a request for communication connection to the counterpart second electronic device through an IP address or port. The counterpart second electronic device can accept the communication connection request of the electronic device 100 when the counterpart second electronic device has a need for data transmission/reception with the electronic device 100. If the communication is connected between the electronic device 100 and the second electronic device, the data can be transmitted/received between the electronic device 100 and the second electronic device on a point-to-point communication basis until the communication connection is disconnected. If the communication is connected between the electronic device 100 and the second electronic device, the electronic device 100 can transmit the data blocks ‘1’, ‘2’, ‘3’ and ‘4’ to the second electronic device.

If the electronic device 100 transmits the data block ‘1’ to the second electronic device, the electronic device 100 can receive from the second electronic device a feedback of a state in which the second electronic device receives the data block ‘1’. If the second electronic device fails to receive some or all of the data block ‘1’ because of a data damage, a data loss or the like in course of receiving the data block ‘1’, the second electronic device can send a request for retransmission of the data block ‘1’ to the electronic device 100. In response to the retransmission request of the second electronic device, the electronic device 100 can retransmit to the second electronic device some or all of the data block ‘1’ corresponding to a data reception failure feedback received from the second electronic device. If the electronic device 100 transmits data 705 of FIG. 7 to the second electronic device, the electronic device 100 can receive from the second electronic device a data reception success feedback notifying that it has succeeded in receiving the data 705 or each of the data blocks ‘1’, ‘2’, ‘3’, and ‘4’ of the data 705. By receiving from the second electronic device the data reception success feedback notifying that it has succeeded in receiving the data 705, the electronic device 100 can end the transmission of the data 705.

Accordingly, the TCP connection method may not cause a data damage or a data loss because the electronic device 100 and the second electronic device can transmit/receive data on a point-to-point connection basis and can periodically confirm a data transmission/reception state during the data transmission/reception, but its relative rate can be low.

The UDP connection method can transmit/receive data without point-to-point connection between the electronic device 100 and the second electronic device. Accordingly, if the electronic device 100 receives a data transmission request of the second electronic device, the electronic device 100 can transmit corresponding data targeting the second electronic device and, during the data transmission, the electronic device 100 may not confirm the reception or non-reception of the data.

Regarding the UDP connection method, the electronic device 100 can transmit data (for example, 705 of FIG. 7) to the second electronic device belonging to the same multicast group. At this time, the electronic device 100 can split the data 705 into data blocks ‘1’, ‘2’, ‘3’, and ‘4’ and transmit the data blocks ‘1’, ‘2’, ‘3’, and ‘4’ to the second electronic device. A third electronic device can send a data 705 transmission request to the electronic device 100. In response to the data 705 transmission request of the third electronic device, the electronic device 100 can transmit to the third electronic device feedback data including already transmitted data information, totally transmitted data information, and the like, thereby enabling the third electronic device to participate in a multicast group and receive the data 705 from the electronic device 100 along with the second electronic device. The electronic device 100 can transmit the corresponding data 705 to the third electronic device which has sent the data 705 transmission request to the electronic device 100. The electronic device 100 can decide a TTL and transmit the data 705, and can decide a transmission path of the data 705 by selecting a router. So, if the TTL becomes ‘0’, the second electronic device or the third electronic device may fail to receive some or all of the data 705 transmitted by the electronic device 100. After the end of the reception of the data 705 from the electronic device 100, the second electronic device or the third electronic device can check the data 705, and can send a feedback of requesting for retransmission of damage data or loss data, to the electronic device 100. Also, if the second electronic device receives the data 705 from the electronic device 100 without loss, the electronic device 100 can request for the second electronic device to transmit the damage data to the third electronic device, and the third electronic device can request for the second electronic device to transmit the damage data.

As described above, the UDP connection method may not check a data transmission/reception state during data transmission/reception in performing data transmission/reception between the electronic device 100 and the second electronic device. So, the UDP connection method can perform faster data transmission than the TCP connection method. But, the second electronic device can receive the data with the data damaged or lost, because the second electronic device does not check a data transmission/reception state until the end of data reception when the electronic device 100 transmits data to the second electronic device.

Particularly, in a case where the UDP connection method uses wireless communication, there is a possibility in which data damage or data loss is caused by a radio wave interfering a network state transmitting/receiving data, a data movement path, and the like. Also, because the UDP connection method can decide the number of passed routers according to setting of a TTL, the excessive setting of the TTL can generate network traffic, decreasing a transmission/reception rate.

The following description can be made for a method of controlling an efficient communication condition through the characteristics of the TCP connection method and the UDP connection method.

In operation 501, the electronic device 100 can split some or all of data (for example, data of FIG. 7) intended to be transmitted into several data blocks and transmit the data blocks, and can control a delay time between the data blocks transmitted, and can decide a TTL. A data transmission/reception rate between the electronic device 100 and the second electronic device, a percentage (i.e., a transmission percentage) of transmitting/receiving data without data damage in the UDP connection method, or the like can be decided according to a communication system environment of the electronic device 100 or the second electronic device transmitting/receiving data with the electronic device 100, or a communication environment such as a communication connection state and the like. In this case, by resetting the volume of the data blocks, the delay time, the TTL, or the like, the electronic device 100 can improve the data transmission/reception rate, the transmission percentage, or the like even in the same communication environment. The electronic device 100 can decide the volume of the data blocks splitting the data, the delay time, the TTL, and the like according to the communication environment. The data blocks each can include an identification code for identification, and the like.

In operation 503, the electronic device 100 can transmit to the second electronic device some or all of the data split according to the data block volume that is decided in operation 501, and can delay the data transmission as long as the delay time that is decided between the respective data blocks in operation 501.

In operation 505, the electronic device 100 can receive from the second electronic device a feedback for the data that is transmitted to the second electronic device.

For example, as in FIG. 7, the electronic device 100 can split data 701 into data blocks ‘1’, ‘2’, ‘3’, ‘4’, and ‘5’. The electronic device 100 can transmit the data blocks ‘1’, ‘2’, and ‘3’ among the data 701 to the second electronic device. The second electronic device can receive the data blocks ‘1’, ‘2’, and ‘3’ from the electronic device 100, and can confirm the data transmission completion of the electronic device 100. If the second electronic device receives only the data blocks ‘1’ and ‘2’ among the data blocks ‘1’, ‘2’, and ‘3’ from the electronic device 100, the second electronic device can confirm the received data blocks ‘1’ and ‘2’ with reference to data information transmitted by the electronic device 100, and can send the electronic device 100 a data reception failure feedback including information notifying that it has failed to receive the data block ‘3’ from the electronic device 100. When sending the data reception failure feedback to the electronic device 100, the second electronic device can send in the TCP connection method.

In operation 507, by receiving the feedback of operation 505 from the second electronic device, the electronic device 100 can obtain a data transmission rate, a data transmission percentage, or the like. According to the condition decided in the monitoring program 114 and the like, the electronic device 100 can determine whether to perform operation 509 or whether to perform operation 511. The condition can be obtained by deciding a value capable of confirming a communication rate, a communication transmission percentage, a statistics situation and the like through the number of receiving the feedback of operation 505 after first performing operation 501, a transmission percentage of data transmission/reception in the feedback, an average transmission percentage of data transmission/reception in at least once or more feedbacks of a last-minute data transmission/reception environment, or the like.

In operation 511, the electronic device 100 can change (i.e., reset) the data blocks of the data intended to be transmitted in operation 501, the delay time, the TTL, and the like.

For instance, the electronic device 100 can change variable values such as the volume of the data blocks, the delay time, the TTL and the like through the monitoring program 114 and the like, and can again perform operations 503 to 505. Also, by deciding the condition of operation 507, the electronic device 100 can again perform operation 511, and can repeatedly perform operation 503 and operation 505.

The electronic device 100 can transmit the same data but get different results according to the data block, the delay time, the TTL and the like, because the electronic device 100 splits data intended to be transmitted into data blocks of various volumes, or changing a delay time, or changing a TTL and transmits the data to the second electronic device.

In operation 509, with reference to values satisfying the condition of operation 507, the electronic device 100 can decide the data block volume, delay time, or TTL efficient for data transmission/reception in a current communication environment, and its corresponding data transmission/reception rate, data transmission percentage, time taken to complete the data transmission/reception and the like through the results of various communication conditions. Also, the electronic device 100 can store information obtained through operation 507 and operation 509, in a monitoring database.

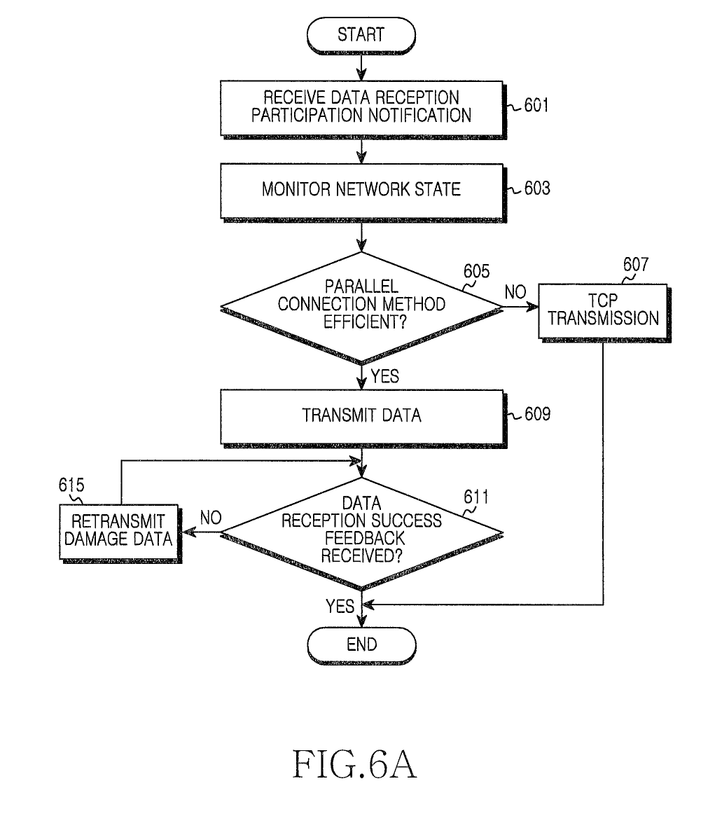

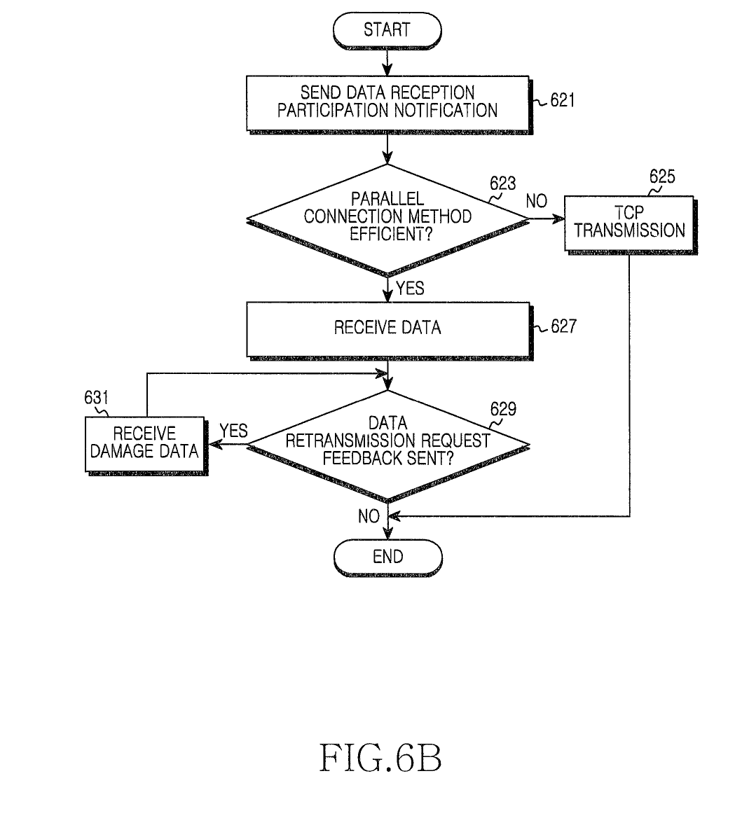

FIG. 6A illustrates a program operation in an electronic device according to the sixth embodiment of the present disclosure.

The electronic device 100 can monitor a communication environment, a data transmission/reception state or the like, and can transmit/receive data in a TCP connection method, a UDP connection method, or a combination of the two connection methods according to the monitoring result or a feedback received from the second electronic device.

In operation 601, the electronic device 100 can receive a data transmission request from the second electronic device. In response to the data transmission request of the second electronic device, the electronic device 100 can transmit data information received up to now, data information currently transmitted, total data information transmitted, or the like, to the second electronic device. By receiving information about transmitted data from the electronic device 100, the second electronic device can take part in a multicast group or a broadcast group and can receive the data from the electronic device 100.

In operation 603, the electronic device 100 can decide a data transmission/reception environment with reference to a monitoring database for a network transmitting/receiving data with the second electronic device.

For example, the electronic device 100 can build the monitoring database through operations of FIG. 5. With reference to data closest to an environment in which the electronic device 100 intends to perform data transmission/reception in the monitoring database, the electronic device 100 can decide the volume of data blocks, a delay time, a TTL and the like. Also, the electronic device 100 can split data to be transmitted according to the decided environment, and can perform a test according to operations of FIG. 5. Through the test, the electronic device 100 can obtain new values for a data transmission/reception rate, a data transmission percentage, a data transmission/reception complete time and the like, and compare the new values with the monitoring database.

In operation 605, the electronic device 100 can decide a connection method of good communication efficiency through a comparison of the communication characteristics of the UDP connection method, the TCP connection method and the like.

For example, the electronic device 100 can compare an expected time taken to complete data transmission in the TCP connection method, a time taken to transmit data in the UDP connection method and retransmit damage data in the TCP connection method to complete data transmission, and the like.

The following description is made for one embodiment of deciding the expected time (i.e., TCP connection time) taken to complete data transmission/reception in the TCP connection method. The electronic device 100 can obtain the expected time taken to transmit/receive the entire data, through a time taken to transmit test data (for example, packet) to the second electronic device many times or during a reference time and receive an Acknowledgement code (ACK), a checksum and the like from the second electronic device.

For another example, the electronic device 100 can obtain the expected time taken to transmit/receive the entire data, through a time taken for the electronic device 100 to transmit data 705 of FIG. 7 or one data block splitting the data 705 of FIG. 7 to the second electronic device and receive from the second electronic device a feedback notifying that it has successfully received the data 705 or the one data block from the electronic device 100, the volume of the data blocks transmitted by the electronic device 100 to the second electronic device, and the like.

The following description is made for one embodiment of deciding the expected time taken to complete data transmission/reception in a parallel connection method of transmitting/receiving data in the UDP connection method and transmitting/receiving lost data in the TCP connection method. Referring to operations 501 to 505 of FIG. 5, the electronic device 100 can transmit some of data blocks splitting data to the second electronic device. And, the second electronic device can send a feedback for data blocks failing in reception among the data blocks after completing the reception of the data blocks. And, the electronic device 100 can obtain an expected time taken to transmit/receive the entire data through a time taken to complete reception of the feedback from the second electronic device starting from when transmitting the data blocks to the second electronic device, and can decide the obtained expected time as a UDP connection transmission/reception time.

The electronic device 100 can apply the embodiments of deciding the expected time taken to complete data transmission/reception in the TCP connection method, and can obtain an expected time taken to, in the TCP connection method, transmit data corresponding to a damage percentage that can occur when transmitting the entire data to the second electronic device, and can decide the obtained expected time as a TCP connection transmission/reception time.

Accordingly, a parallel connection time can be decided in a method using the UDP connection transmission/reception time and the TCP connection transmission/reception time together. The electronic device 100 can decide an effective connection method through a comparison of the TCP connection time and the parallel connection time.

If the electronic device 100 is already transmitting data the moment it receives a data transmission request from the second electronic device, the electronic device 100 may fail to perform a process of resetting the data block volume of operation 603, the delay time, the TTL and the like. In this case, in operation 605, the electronic device 100 can apply database information of data transmission/reception between the electronic device 100 and the second electronic device, information of data transmission/reception with a third electronic device that is already transmitting, or the like to a communication environment of the electronic device 100 and the second electronic device, and decide the connection method.

The network state monitoring of operation 603 that can precede in performing operation 605 can be carried out by data transmitted by the electronic device 100, or can be carried out by test data transmitted/received between the electronic device 100 and the second electronic device.

If the parallel connection method is decided, the electronic device 100 can perform operation 607. If the TCP connection method is decided, the electronic device 100 can perform operation 607.

In operation 607, the electronic device 100 can transmit data to the second electronic device through TCP connection.

For example, the electronic device 100 or the second electronic device can send a communication connection request to the counterpart second electronic device or the counterpart electronic device 100 through an IP address or a port. The counterpart second electronic device or counterpart electronic device 100 can accept the communication connection request of the electronic device 100 or second electronic device, thereby constructing a dedicated channel between the electronic device 100 and the second electronic device. If a dedicated TCP channel capable of transmitting/receiving data has been already established between the electronic device 100 and the second electronic device, the electronic device 100 and the second electronic device just transmit/receive the data in a TCP connection method without a need to construct a new channel.

In a case where the electronic device 100 has already transmitted data in the UDP connection method in operation 603, the electronic device 100 can receive a feedback for damage data from the second electronic device, and can retransmit the damage data or remnant data to the second electronic device. The second electronic device can send a feedback for data received in a data block unit, a packet unit or the like to the electronic device 100, and can receive the data from the electronic device 100 without a data damage or data loss.

If the electronic device 100 completes data reception in operation 607, the electronic device 100 can terminate the data transmission/reception operations of FIG. 6A.

In operation 609, the electronic device 100 can split data in a data block unit and transmit the data. The electronic device 100 can generate a predefined UDP socket and the like, and can set a socket option such as the TTL and the like, and can transmit data directly to a target such as an IP address and the like or to a predefined group. The second electronic device can receive the data from the electronic device 100 by generating a predefined UDP socket and setting a socket option of participation in the predefined group capable of receive the data.

In operation 611, the electronic device 100 can receive the feedback sent by the second electronic device.

For instance, the second electronic device can confirm the data that is received in the data block unit and the like from the electronic device 100. The second electronic device can confirm received data blocks and determine if there is damaged or lost information.

As illustrated in FIG. 7, the electronic device 100 can split data 701 into data blocks ‘1’, ‘2’, ‘3’, ‘4’, and ‘5’ and transmit the data blocks ‘1’, ‘2’, ‘3’, ‘4’, and ‘5’ to the second electronic device. The second electronic device can determine whether it has received all of the data blocks ‘1’, ‘2’, ‘3’, ‘4’, and ‘5’ of the data 701 from the electronic device 100, or whether it can complete the data 701 by received data blocks. If the second electronic device fails in reception because the data blocks ‘1’, ‘3’, and ‘4’ have been damaged or lost, the second electronic device can send the electronic device 100 a retransmission request feedback that includes information about the data 701 such as a loss percentage 60%, the damaged or lost data blocks ‘1’, ‘3’, and ‘4’, and the like. If the second electronic device can receive all the data blocks ‘1’, ‘2’, ‘3’, ‘4’, and ‘5’ without damage and construct the data 701, the second electronic device can send a data reception success feedback to the electronic device 100. At this time, when sending the data reception success feedback to the electronic device 100, the second electronic device can send in the TCP connection method.

If receiving the data retransmission request feedback from the second electronic device in operation 611, the electronic device 100 can perform operation 615. If receiving no feedback during a reference time or receiving the data reception success feedback from the second electronic device, the electronic device 100 can terminate the data transmission/reception operations of FIG. 6A.

In operation 615, the electronic device 100 can retransmit data blocks corresponding to the received data retransmission request feedback, to the second electronic device through the TCP connection method or the UDP connection method.

For example, the electronic device 100 transmits the data 701 of FIG. 7 to the second electronic device, and the electronic device 100 receives from the second electronic device a data retransmission request feedback which includes information requesting retransmission of the data blocks ‘1’, ‘3’, and ‘4’ and the like. In this case, the electronic device 100 can confirm the information that is included in the data retransmission request feedback sent by the second electronic device.

The electronic device 100 can confirm, from feedback data, the condition such as the volume (i.e., capacity) of the entire data 701 and data blocks retransmission-requested by the second electronic device, a percentage of the retransmission-requested data blocks compared to the capacity of the entire data 701, a communication state between the electronic device 100 and the second electronic device, and the like. The electronic device 100 can decide one connection method among the TCP connection method and the UDP connection method through a comparison of communication states of the TCP connection method and the UDP connection method between the electronic device 100 and the second electronic device. The electronic device 100 can retransmit the data blocks ‘1’, ‘3’, and ‘4’ retransmission-requested by the second electronic device, to the second electronic device.

For instance, the electronic device 100 can receive a request for retransmission of the data blocks ‘1’, ‘3’, and ‘4’ from the second electronic device. In a case where the electronic device 100 decides to retransmit in the TCP connection method only when a capacity of retransmission requested data is equal to or is less than 50% of the capacity of the entire data 701 in settings of the monitoring program 114 and the like, the electronic device 100 can determine whether the data blocks ‘1’, ‘3’, and ‘4’ are equal to or are less than 50% of the capacity of the entire data 701. If it is determined not equal to or less than 50%, the electronic device 100 can retransmit the data blocks ‘1’, ‘3’, and ‘4’ in the UDP connection method.

If completing the retransmission of the retransmission-requested data blocks, the electronic device 100 can again perform operation 611.

FIG. 6B is a flowchart illustrating a program operation in an electronic device according to the seventh embodiment of the present disclosure.

The electronic device 100 can transmit/receive data in a TCP connection method, a UDP connection method, or a combination of the two connection methods according to a communication environment with the second electronic device, monitoring of a data transmission/reception state and the like, or the result of a feedback of the electronic device 100 dependent on data reception.

In operation 621, the electronic device 100 can confirm that it starts data transmission/reception with the second electronic device.

For instance, in a case where the electronic device 100 transmits/receives data with the second electronic device in the UDP connection method, the electronic device 100 can send a data reception participation notification to the second electronic device and can receive information about the transmission completed data, remnant data after transmission, a total data capacity, and the like from the second electronic device. The electronic device 100 can receive the data by participating in a network group that is transmitting data.

For another instance, in a case where the electronic device 100 transmits/receives data with the second electronic device in the TCP connection method, the electronic device 100 can send a communication connection request to the counterpart second electronic device through an IP address or a port. The counterpart second electronic device can accept the communication connection request of the electronic device 100 when there is a need for data transmission/reception with the electronic device 100. If communication is connected between the electronic device 100 and the second electronic device, data can be transmitted/received on a point-to-point communication basis between the electronic device 100 and the second electronic device until the communication connection is disconnected.

In operation 623, the electronic device 100 can decide one connection method among the UDP connection method and the TCP connection method in order to transmit/receive the data with the second electronic device.

For instance, if the electronic device 100 receives the information about the transmission completed data, the remnant data after transmission, the total data capacity, and the like, the electronic device 100 can receive the data from the second electronic device, by participating in a network group to which the second electronic device is transmitting the data.

For another instance, if the electronic device 100 receives a TCP connection request form the second electronic device, the electronic device 100 can accept the TCP connection request, and can set a data reception environment and the like and construct a dedicated channel for point-to-point data transmission/reception between the electronic device 100 and the second electronic device, and can receive data from the second electronic device.

If the electronic device 100 receives the TCP connection request from the second electronic device, the electronic device 100 can construct the point-to-point data transmission/reception channel, and can perform operation 625.

If there is no TCP connection request during a reference time from the second electronic device, the electronic device 100 can perform operation 627.

In operation 627, the electronic device 100 can receive data from the second electronic device in the UDP connection method.

For instance, the electronic device 100 can receive data that is split in a data block unit from the second electronic device. The second electronic device can generate a predefined UDP socket and the like, and can set a socket option such as a TTL and the like, and can transmit data directly to a target such as an IP address and the like or to a predefined group. The electronic device 100 can receive the data from the second electronic device by generating a predefined UDP socket and setting a socket option such as participation in the predefined group capable of receiving the data.

In operation 629, the electronic device 100 can send a feedback for the received data to the second electronic device.

For example, the electronic device 100 can confirm the data that is received from the second electronic device in a data block unit and the like. The electronic device 100 can confirm received data blocks and determine if there is a damaged or lost block among the data blocks.

As illustrated in FIG. 7, if the second electronic device splits data 705 into data blocks ‘1’, ‘2’, ‘3’, and ‘4’ and transmits the data blocks ‘1’, ‘2’, ‘3’, and ‘4’ to the electronic device 100, the electronic device 100 can receive the data 705 from the second electronic device. The electronic device 100 can determine whether it has received all of the data blocks ‘1’, ‘2’, ‘3’, and ‘4’ of the received data 705, or whether it can complete the data 705 by received data blocks. If the received data blocks are damaged or there is a data block failing in reception, the electronic device 100 can send the second electronic device a feedback of information about the reception of the data 705. For example, if data blocks ‘1’, ‘1’, ‘2’, ‘4’, and ‘4’ are received and a data transmission percentage is 75% of the data 705, the electronic device 100 can process duplicate data blocks, and can confirm the received data blocks. The electronic device 100 can send the second electronic device a feedback including information of such as receiving the data blocks ‘1’, ‘2’, and ‘4’ right, requesting retransmission of the data block ‘3’, and the like. If the electronic device 100 receives the data blocks ‘1’, ‘2’, ‘3’, and ‘4’ constructing the data 705 without loss and completes the data 705 by the data blocks ‘1’, ‘2’, ‘3’, and ‘4’, the electronic device 100 can send a data reception success feedback to the second electronic device. The electronic device 100 can send the data reception success feedback in the TCP connection method.

If the electronic device 100 sends the second electronic device the data retransmission request feedback in operation 629, the electronic device 100 can perform operation 631. Meantime, if the electronic device 100 sends the second electronic device the data reception success feedback in operation 629, the electronic device 100 can terminate the data transmission/reception operations of FIG. 6B.

In operation 631, the electronic device 100 can receive retransmitted data blocks from the second electronic device, in the TCP connection method or the UDP connection method.

For instance, the electronic device 100 can receive data blocks constructing the data 705 of FIG. 7, and can send the second electronic device a retransmission request feedback for a data block ‘2’ failing in right reception, and can receive the data block ‘2’ from the second electronic device.

If the electronic device 100 is in a TCP connection with the second electronic device and the second electronic device retransmits a data block corresponding to a data retransmission feedback in the TCP connection method, the electronic device 100 can receive the corresponding data block on a point-to-point basis from the second electronic device without loss. If the electronic device 100 is not in the TCP connection with the second electronic device, the electronic device 100 can receive a TCP connection request from the second electronic device, and can construct a channel for point-to-point data transmission/reception and receive a corresponding data block from the second electronic device on a point-to-point basis without loss. The electronic device 100 can receive in the UDP connection method the data block that the second electronic device retransmits to a target such as an IP address and the like or to a predefined group. If the electronic device 100 receives all of the retransmission-requested data blocks, the electronic device 100 can perform operation 629.

FIG. 7 illustrates data transmitted/received in an electronic device according to the eighth embodiment of the present disclosure.

In transmitting data to the second electronic device, the electronic device 100 can split the data into data blocks of a predetermined volume, and can control a time interval (i.e., a delay time) at which no data is transmitted between the transmitted data blocks.

By adjusting the volume of the data block and a delay time according to a data transmission/reception environment with the second electronic device, a data processing capability of the electronic device 100 and the second electronic device, or the like, the electronic device 100 can decrease a predetermined portion of a data loss that can be generated when transmitting the data in the UDP connection method.

For instance, three embodiments of splitting data 701, 703, and 705 of the same volume by different data block volumes and different delay time can be described with reference to FIG. 7.

Regarding the data 701, the electronic device 100 can split the data 701 into five data blocks ‘1’, ‘2’, ‘3’, ‘4’, and ‘5’. The volume of the data blocks can be decided among several data block volumes capable of efficiently processing the data 701 in an Operating System (OS) of the electronic device 100, or can be decided with reference to a data processing capability of the electronic device 100 or the second electronic device transmitting/receiving the data 701 with the electronic device 100, or can be decided in a method of deciding with reference to a data transmission/reception state between the electronic device 100 and the second electronic device and the like.

Regarding the data 703, the electronic device 100 can split the data 703 into data blocks of a volume smaller than the volume of the data blocks of the data 701. The electronic device 100 can split the data 703 into the data blocks of the same number as the number of the data blocks of the data 701 by deciding a delay time longer than that of the data 701.

Regarding the data 705, the electronic device 100 can decide the same delay time as that of the data 701, and can split the data 705 into four data blocks ‘1’, ‘2’, ‘3’, and ‘4’ by deciding the volume of the data blocks ‘1’, ‘2’, ‘3’, and ‘4’ large. In a case where a damage percentage of data transmission/reception between the electronic device 100 and the second electronic device is small, transmitting the data 705 having a greater data block volume than the data 701 but having four data blocks and four delay time can achieve relatively faster data transmission than transmitting the data 701 having five data blocks and five delay time.

Likewise, the electronic device 100 can split the data 201 of FIG. 2, the data 301 of FIG. 3, and the data 401 of FIG. 4 into data blocks of a predetermined volume according to a data transmission/reception state with the second electronic device, a data processing capability of the electronic device 100 and the second electronic device, or the like, and can transmit the data blocks at a predetermined delay time interval.

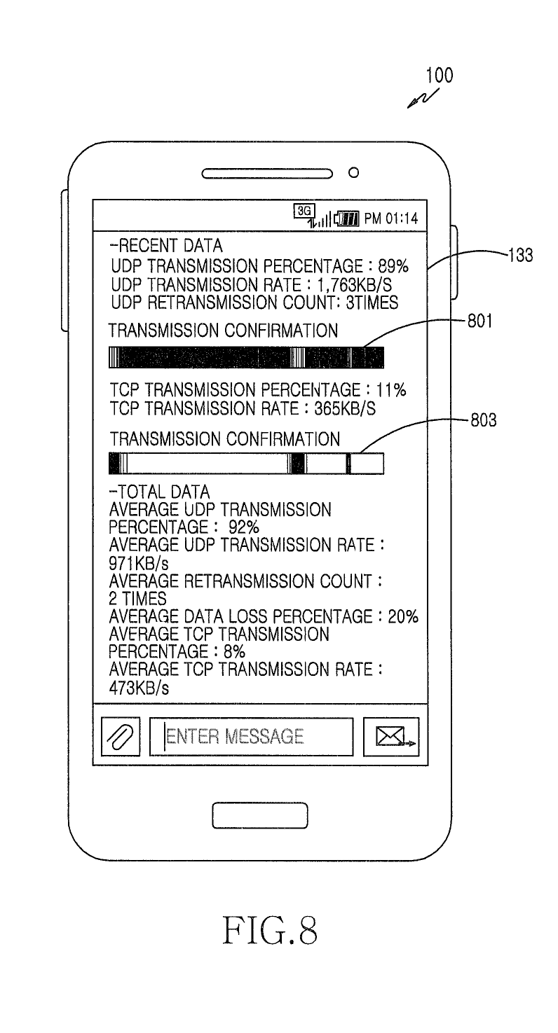

FIG. 8 illustrates a construction of a UI operation dependent on data processing in an electronic device according to the ninth embodiment of the present disclosure.

The electronic device 100 can display a measured data transmission/reception state between the electronic device 100 and the second electronic device, a data transmission/reception state stored in a database, or the like.

Referring to FIG. 8, the electronic device 100 can display a data transmission/reception state dependent on a connection method of recently transmitted/received data and totally transmitted/received data.

Regarding an item of ‘recent data’, the electronic device 100 can display a percentage (89%) of data transmitted or received in a UDP connection method compared to recent transmitted or received data, a rate (1,763 KB/S) of transmission or reception of the UDP connection method, the number (3 times) of retransmitting or re-receiving data in the UDP connection method, and the like. And, the electronic device 100 can display data blocks of the entire data transmitted or received in the UDP connection method, with a bar graph 801.

Also, the electronic device 100 can display a percentage (11%, it can be a data loss percentage of the UDP connection method) of data transmitted or received in the TCP connection method, a rate (365 KB/S) of transmission or reception of the TCP connection method, or the like. And, the electronic device 100 can display data blocks of the entire data transmitted or received in the TCP connection method, with a bar graph 803 (or a color-inversion graph of the bar graph 801).

Regarding an item of ‘total data’, the electronic device 100 can display an average transmission percentage (92%) of transmitting or receiving data in the UDP connection method compared to the total data transmitted/received through a communication system by the electronic device 100, an average rate (971 KB/S) of transmitting or receiving the data in the UDP connection method, an average number (2 times) of retransmitting or re-receiving the data in the UDP connection method, an average data loss percentage (20%) of when transmitting or receiving the data in the UDP connection method, an average transmission percentage (8%) of transmitting or receiving the data in the TCP connection method, an average rate (473 KB/S) of transmitting or receiving the data in the TCP connection method, and the like.

The electronic device 100 can display a data transmission/reception state between the electronic device 100 and the second electronic device and the like through the touch screen 133 of the electronic device 100 or a second display unit (not shown) as in FIG. 8, or can output the same using sound such as signal sound, voice and the like through the speaker 142 and the like.

Also, the electronic device 100 can store information of the item of ‘recent data’ together with the item of ‘total data’ in a database and, by using the information of the item of ‘recent data’ or the item of ‘total data stored in the database, the electronic device 100 can decide a data transmission/reception state in operation 509 of FIG. 5, and can determine whether to transmit data in the UDP connection method or whether to transmit/receive the data in the TCP connection method in operation 605 or 615 of FIG. 6A.

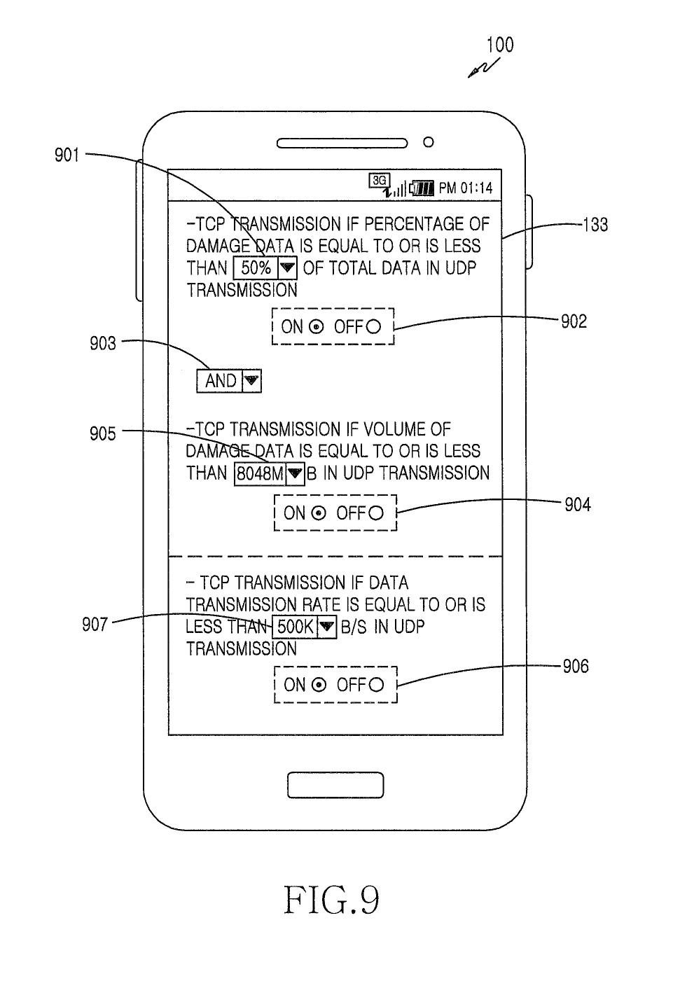

FIG. 9 illustrates a construction of a UI operation dependent on data processing in an electronic device according to the tenth embodiment of the present disclosure.

The electronic device 100 can decide a TCP connection method or a UDP connection method in transmitting/receiving data with the second electronic device.

Referring to FIG. 9, the electronic device 100 can decide a data transmission/reception method in operation 605 or 615 of FIG. 6A, according to setting information of the monitoring program 114 and the like.

For example, in operation 605, in a case where the electronic device 100 transmits data to the second electronic device in the UDP connection method with reference to information of a database, the electronic device 100 can decide to transmit the data in the TCP connection method when a damage data percentage is equal to or is less than 50% (901). Here, the damage data percentage is not limited only to 50% (901) and can select other numerals or can be a numeral directly input and decided by a user. In ‘ON’ or ‘OFF’ settings (902), if ‘ON’ is selected, the electronic device 100 can apply (i.e., activate) settings of deciding to transmit in the TCP connection method according to the damage data percentage. Meantime, if ‘OFF’ is selected, the electronic device 100 can inactivate the settings of deciding to transmit in the TCP connection method according to the damage data percentage. Likewise, ‘ON’ or ‘OFF’ settings (904) and (906) can decide activation or inactivation according to ‘ON’ or ‘OFF’.

For another example, in operation 605, in a case where the electronic device 100 transmits data to the second electronic device in the UDP connection method with reference to the information of the database, the electronic device 100 can decide to transmit in the TCP connection method when a damage data volume is equal to or is less than 8048 MB (905). Here, the damage data volume is not limited only to 8048 MB (905), and can select other numerals or can be a numeral directly input and decided by a user.

In operation 605, the electronic device 100 can confirm that it can select ‘AND’ (903). If the electronic device 100 selects the ‘AND’ (903), in a case where the electronic device 100 transmits data to the second electronic device in the UDP connection method, the electronic device 100 is able to transmit in the TCP connection method when the damage data percentage is equal to or is less than 50% (901) and the damage data volume is 8048 MB (905).

For another example, in operation 605, if the electronic device 100 selects ‘OR’ (903), the electronic device 100 is able to transmit in the TCP connection method when the damage data percentage is equal to or is less than 50% (901) or the damage data volume is 8048 MB (905). Here, the condition (903) can be other conditions such as ‘NAND’ and the like as well as ‘AND’ or ‘OR’.

For further example, in operation 605, in a case where the electronic device 100 transmits data to the second electronic device in the UDP connection method with reference to the information of the database, the electronic device 100 can decide to transmit in the TCP connection method when an average data transmission rate is equal to or is less than 500 KB/S (907). Here, the average data transmission rate 907 is not limited only to 500 K, and can select other numerals and can be a numeral directly input and decided by a user.

Also, the settings of operation 605 are not limited to referring to the database, and can decide the data transmission method such as the TPC connection method or the UDP connection method with reference to information of a last-minute data transmission/reception state, result information acquired by transmitting/receiving test data in operations of FIG. 5, and the like.

Also, the aforementioned description is not limited only to operation 605 and can be applied to deciding the data transmission method such as the TCP connection method or the UDP connection method even in operation 615.

As described above with reference to FIG. 9, the electronic device 100 can decide the TCP connection method or the UDP connection method according to information decided in a setting menu of the monitoring program 114 and the like to transmit data. The electronic device 100 can automatically decide the data block volume and delay time corresponding to the communication environment of the electronic device 100 and the second electronic device, the communication connection method (i.e., the TCP connection method or the UDP connection method), or the like, with reference to the database storing the information decided in the setting, for example, the communication environment such as the data damage percentage of the UDP connection method, the damage data volume of the UDP connection method, the data transmission rate of the UDP connection method, and the like, or the information such as the data transmission/reception state, the data block volume and delay time corresponding to the data transmission/reception state, and the like.

Methods according to embodiments disclosed in claims and/or specification of the present disclosure can be implemented in a form of hardware, software, or a combination of the hardware and the software.

In a case of implementation of the software form, a computer-readable storage medium storing one or more programs (i.e., software modules) can be provided. One or more programs stored in the computer-readable storage medium are configured to be executable by one or more processors within the electronic device 100. One or more programs include instructions for enabling the electronic device 100 to execute the methods according to the embodiments disclosed in the claims and/or specification of the present disclosure.

These programs (i.e., software modules or software) can be stored in a Random Access Memory (RAM), a nonvolatile memory including a flash memory, a Read Only Memory (ROM), an Electrically Erasable Programmable ROM (EEPROM), a magnetic disk storage device, a Compact Disk ROM (CD-ROM), a Digital Versatile Disk (DVD) or an optical storage device of other form, and a magnetic cassette. Or, the programs can be stored in a memory constructed by a combination of some or all of them. Also, each configuration memory can be included in plural.

Further, the programs can be stored in an attachable storage device accessible to the electronic device through a communication network such as the Internet, an intranet, a Local Area Network (LAN), a Wireless LAN (WLAN) or a Storage Area Network (SAN), or a communication network constructed by a combination of them. The attachable storage device can access the electronic device 100 through an external port.

Furthermore, a separate storage device on a communication network can gain access to the portable electronic device 100.

Accordingly, embodiments of the present disclosure can select and variably apply a UDP connection method or a TCP connection method considering a data transmission/reception environment of a wireless network and, if selecting the UDP connection method, can decrease a data loss, achieving fast reliable data transmission.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. A method in an electronic device, the method comprising:
transmitting data to a second electronic device in a User Datagram Protocol (UDP) method;
receiving feedback information on a reception quality of the data from the second electronic device; and
transmitting partial data of the data, the partial data corresponding to the feedback information in a Transmission Control Protocol (TCP) method or the UDP method,
wherein the reception quality of the data indicates a successful reception ratio or a failed reception ratio among the data.

2. The method of claim 1, further comprising:
determining which one of the TCP method or the UDP method for transmitting the partial data of the data based on a damage percentage of received data comprised in the feedback information received from the second electronic device.

3. The method of claim 2, further comprising:
determining which one of the TCP method or the UDP method for transmitting the partial data of the data based on a reception rate of the received data additionally comprised in the feedback information received from the second electronic device.

4. The method of claim 2, wherein the operation of transmitting the partial data of the data in the TCP method or the UDP method is decided additionally considering a data volume of the partial data of the data.

5. The method of claim 1, wherein the operation of transmitting the partial data of the data in the TCP method or the UDP method is decided according to a data transmission rate of the operation of transmitting, by the electronic device, the data to the second electronic device in the UDP method and a damage percentage of received data comprised in the feedback information received from the second electronic device.

6. The method of claim 5, wherein the data transmission rate of the operation of transmitting, by the electronic device, the data to the second electronic device in the UDP method is information acquired from database information of the electronic device.

7. The method of claim 1, wherein the operation of transmitting the partial data of the data in the TCP method or the UDP method is decided additionally considering a data transmission rate of the operation of transmitting, by the electronic device, the data to the second electronic device in the UDP method and a data volume of the partial data of the data.

8. The method of claim 1, further comprising the operation of requesting for a third electronic device having received the partial data of the data corresponding to the feedback information to transmit the partial data to the second electronic device.

9. A method in an electronic device, the method comprising the operations of:
receiving transmitted data from a second electronic device in a User Datagram Protocol (UDP) method;
transmitting feedback information about the data received from the second electronic device, to the second electronic device; and
receiving partial data of the data, the partial data corresponding to the feedback information in a Transmission Control Protocol (TCP) method or the UDP method,
wherein the feedback information comprises a reception quality of the data indicating a successful reception ratio or a failed reception ratio among the data.

10. The method of claim 9, further comprising the operation of receiving the partial data from a third electronic device that has received the data from the electronic device.

11. The method of claim 9, wherein the feedback information comprises at least one among information about a data reception rate of receiving the data from the second electronic device in the UDP method, a damage percentage of data reception of the UDP method, and a data transmission/reception rate of the TCP method, and the partial data of the data whose retransmission is requested.

12. An electronic device comprising:
at least one processor configured to execute computer programs;
at least one communication system configured to communicate with a second electronic device;
at least one memory configured to store data and instructions; and
at least one program stored in the memory and executed by the at least one processor,
wherein the program comprises instructions for:
transmitting data to a second electronic device in a User Datagram Protocol (UDP) method;
receiving feedback information on a reception quality of the data from the second electronic device; and
transmitting partial data of the data, the partial data corresponding to the feedback information in a Transmission Control Protocol (TCP) method or the UDP method.

13. The device of claim 12, wherein the program comprises an instruction of processing to transmit the partial data of the data in the TCP method or the UDP method according to at least one of a damage percentage of received data comprised in the feedback information received from the second electronic device, a reception rate of the received data, and a data volume of the partial data of the data.

14. The device of claim 12, wherein the program comprises an instruction of processing to transmit the partial data of the data in the TCP method or the UDP method according to a data transmission rate of the operation of transmitting, by the electronic device, the data to the second electronic device in the UDP method and a damage percentage of received data comprised in the feedback information received from the second electronic device.

15. The device of claim 14, wherein the program comprises an instruction for acquiring the data transmission rate of the operation of transmitting, by the electronic device, the data to the second electronic device in the UDP method, from database information of the electronic device.

16. The device of claim 12, wherein the program comprises an instruction of processing to transmit the partial data of the data in the TCP method or the UDP method additionally considering a data transmission rate of the operation of transmitting, by the electronic device, the data to the second electronic device in the UDP method and a data volume of the partial data of the data.

17. The device of claim 12, wherein the program comprises an instruction of requesting for a third electronic device having received the partial data of the data corresponding to the feedback information to transmit the partial data to the second electronic device.

18. An electronic device comprising:
at least one processor for executing computer programs;
at least one communication system for communicating with a second electronic device;
at least one memory for storing data and instructions; and
at least one program stored in the memory and executed by the at least one processor,
wherein the program comprises instructions for:
receiving transmitted data from a second electronic device in a User Datagram Protocol (UDP) method;
transmitting feedback information about the data received from the second electronic device, to the second electronic device; and
receiving partial data of the data, the partial data corresponding to the feedback information in a Transmission Control Protocol (TCP) method or the UDP method.

19. The device of claim 18, wherein the program comprises an instruction of processing to comprise as the feedback information at least one among information about the partial data failing in reception among the data and information about a data reception rate of receiving the data from the second electronic device in the UDP method, a damage percentage of data reception of the UDP method, and a data transmission/reception rate of the TCP method.

20. The device of claim 18, wherein the program comprises an instruction of processing to receive the partial data from a third electronic device that has received the data from the electronic device.
